(19) United States
(12) Patent Application Publication
(10) Pub. No.: US 2016/0120269 A1
(43) Pub. Date: May 5, 2016

(54) Buckle Structure for a Seat Belt of a Race Car

(71) Applicant: Taiwan Racing Products Co., Ltd., Changhua County (TW)

(72) Inventor: Wen-Yuan Wu, Changhua County (TW)

(21) Appl. No.: 14/527,821

(22) Filed: Oct. 30, 2014

(51) Int. Cl. A44B 11/25; B60R 22/12

(52) U.S. Cl. CPC A44B 11/2542; A44B 11/2561; B60R 22/12

(57) ABSTRACT

A buckle structure for a seat belt of a race car contains: a buckle and plural fastening pieces, the buckle includes an upper cover, a lower cover, an unfastening member, and a locking device. The upper cover and the lower cover are formed in a disc shape and are connected together, and the upper cover has plural holes defined around a peripheral side thereof relative to the lower cover. Each hole has two long fringes and two short fringes, one of the two long fringes has a tilted guiding face, the other of the two long fringes has a guide rim, and each short fringe has a guiding periphery, such that when each fastening piece is guided to fastened with the buckle quickly. The buckle includes a marking block mounted on an outer peripheral side thereof to help determine a location where the connector of each fastening piece is inserted.

### BACKGROUND OF THE INVENTION

1. Field of the Invention

The present invention relates to a buckle assembly, and more particularly to a buckle structure for a seat belt of a racing car which inserts a connector of each fastening piece into one of plural holes of a buckle quickly.

2. Description of the Prior Art

A seat belt is employed to prevent a driver and passengers from bumping a steering wheel or a windshield in a car crash or during an emergency brake, thus reducing injuries and deaths.

The seat belt is fixed in common cars or race car. As shown in FIG. 12, a conventional buckle structure for a seat belt of a race car contains: a buckle B1 and a plurality of fastening pieces B2, wherein the buckle B1 includes an upper cover 60A and a lower cover 60B which are connected together, plural holes 61 defined around an outer peripheral side of the upper cover 60A relative to the lower cover 60B, a partition 62 arranged between any two of the plural holes 61, a rotatable unfastening member 70 fixed on a top end of the upper cover 60A and driving a locking device mounted in the upper cover 60A and the lower cover 60B to operate. Each fastening piece B2 includes a first end connecting with a seat belt 80 and includes a second end having a connector 90 with a lock aperture 91, wherein the connector 90 is inserted into one of the plural holes 61 of the buckle B1, the one of the plural holes 61 is engaged with the locking device, and when rotating the unfastening member 70, the locking device is removed from the lock aperture 91.

However, there is no any guiding member configured around each hole, so a racing driver has to wear a neck guard and tie the seat belt, such that the racing driver is limited by the neck guard and the seat belt, and he/she cannot bow his/her head to see whether the connecter is engaged with the buckle, thus causing operational inconvenience. Moreover, there is no any distinguishing element arranged on the buckle, the racing driver cannot insert the connector into one of the plural holes exactly and quickly.

The present invention has arisen to mitigate and/or obviate the afore-described disadvantages.

### SUMMARY OF THE INVENTION

The primary objective of the present invention is to provide a buckle structure for a seat belt of a racing car which contains a tilted guiding face and a guide rim defined on two long fringes of each of plural holes, and two guiding peripheries formed on two short fringes of each hole, such that when a racing driver is limited by a neck guard and a seat belt and cannot see whether a connecter is engaged with a buckle, the tilted guiding face, the guide rim, and the guiding periphery guide the connector to insert into and engage with the buckle quickly and exactly, thus enhancing using convenience.

Another objective of the present invention is to provide a buckle structure for a seat belt of a racing car which contains a marking block mounted on an outer peripheral side of the buckle to help insert the connector of each fastening piece into one of the plural holes exactly and quickly by ways of the marking block.

To obtain above-mentioned objectives, a buckle structure for a seat belt of a racing car which provided by the present invention contains: a buckle and a plurality of fastening pieces.

The buckle includes an upper cover, a lower cover, an unfastening member, and a locking device.

The upper cover and the lower cover are formed in a disc shape and are connected together, the upper cover has plural holes defined around a peripheral side thereof relative to the lower cover, and each hole has two long fringes corresponding to the upper cover and the lower cover, each hole also has two short fringes defined between the two long fringes and between the upper cover and the lower cover, between any two of the plural holes beings defined a partition, and one of the two long fringes of each hole adjacent to the upper cover has a tilted guiding face, a depth of which increases toward each hole, and the other of the two long fringes of each hole proximate to the lower cover has a guide rim, a depth of which increases toward each hole, each short fringe of each hole has a guiding periphery decreasing inwardly and slanting toward each hole.

The unfastening member is rotatably fixed on the upper cover.

The locking device is mounted between the upper cover and the lower cover and is driven by the unfastening member.

Each fastening piece has a first end connecting with a seat belt and a second end having a connector on which a lock aperture is formed.

The connector of each fastening piece is inserted into one of the plural holes of the buckle, and the lock aperture of the connector is engaged with the locking device, and when rotating the unfastening member, the locking device is driven to disengage from the one of the plural holes. In addition, when the connector is inserted into the one of the plural holes, it is guided to slide into the one of the plural holes by ways any one of the tilted guiding face, the guide rim, and the guiding periphery.

### BRIEF DESCRIPTION OF THE DRAWINGS

FIG. 1 is a perspective view showing the exploded components of a buckle structure for a seat belt of a racing car according to a preferred embodiment of the present invention.

FIG. 2 is a perspective view showing the assembly of the buckle structure for the seat belt of the racing car according to the preferred embodiment of the present invention.

FIG. 3 is a plan view showing the assembly of the buckle structure for the seat belt of the racing car according to the preferred embodiment of the present invention.

FIG. 4 is a cross sectional view taken along lines A-A of FIG. 2.

FIG. 5 is a cross sectional view taken along lines B-B of FIG. 2.

FIG. 6 is a cross sectional view showing each connector being guided to slide one of plural holes according to the preferred embodiment of the present invention.

FIG. 7 is another cross sectional view showing each connector being guided to slide one of plural holes according to the preferred embodiment of the present invention.

FIG. 8 is. also another cross sectional view showing each connector being guided to slide one of plural holes according to the preferred embodiment of the present invention.

FIG. 9 is also another cross sectional view showing each connector being guided to slide one of plural holes according to the preferred embodiment of the present invention.

FIG. 10 is a cross sectional view showing each fastening piece being inserted into and engaged with one of the plural holes according to the preferred embodiment of the present invention.

FIG. 11 is a partial plan view showing a marking block helping a racing driver inserts the connector into one of the plural holes exactly according to the preferred embodiment of the present invention.

FIG. 12 is a perspective view of a conventional buckle structure for a seat belt of a racing car

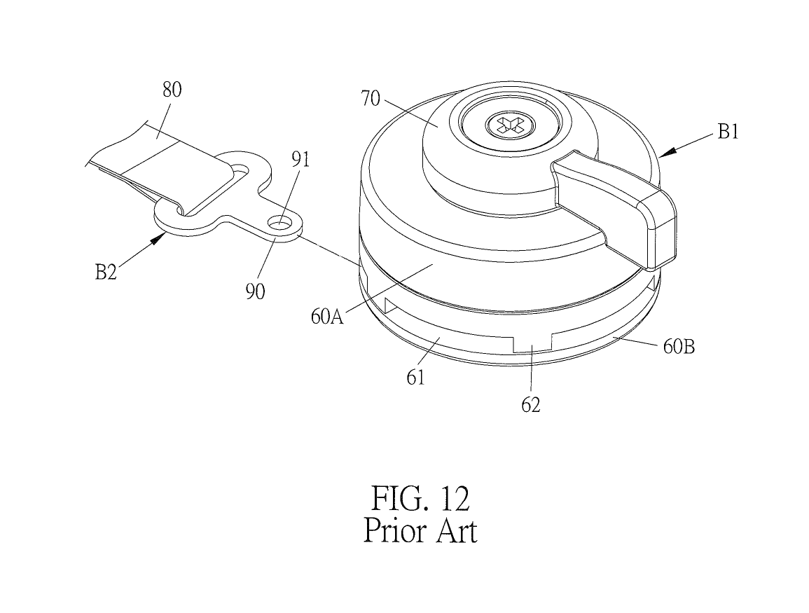

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

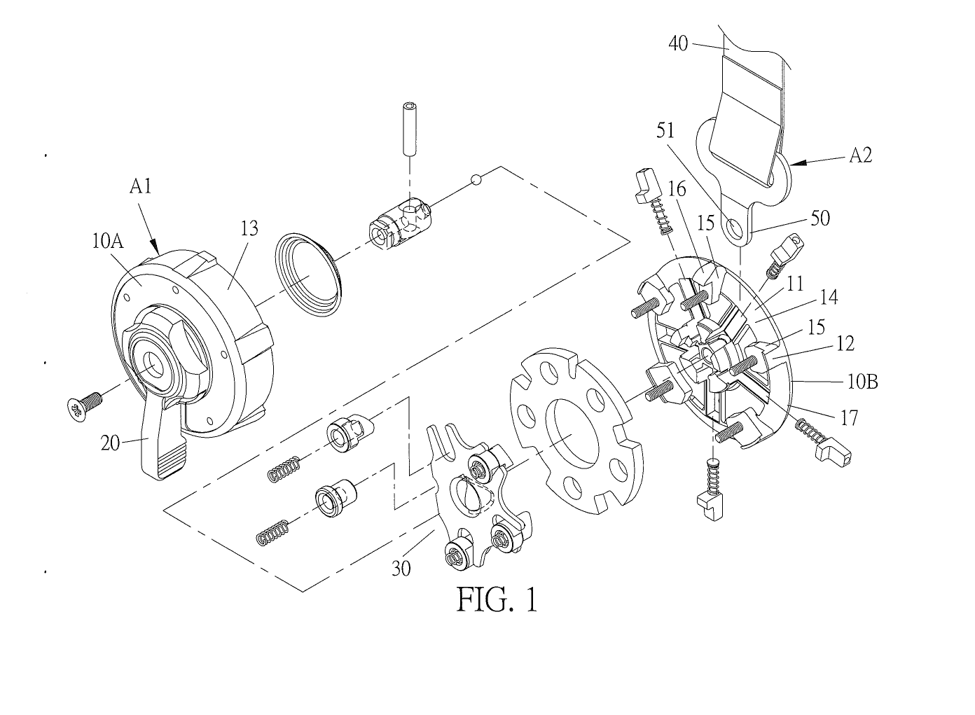

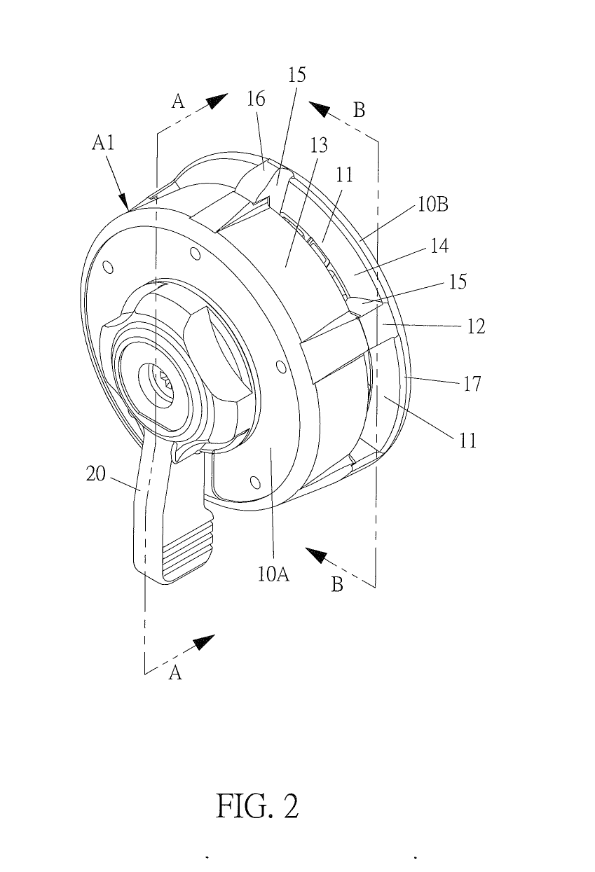

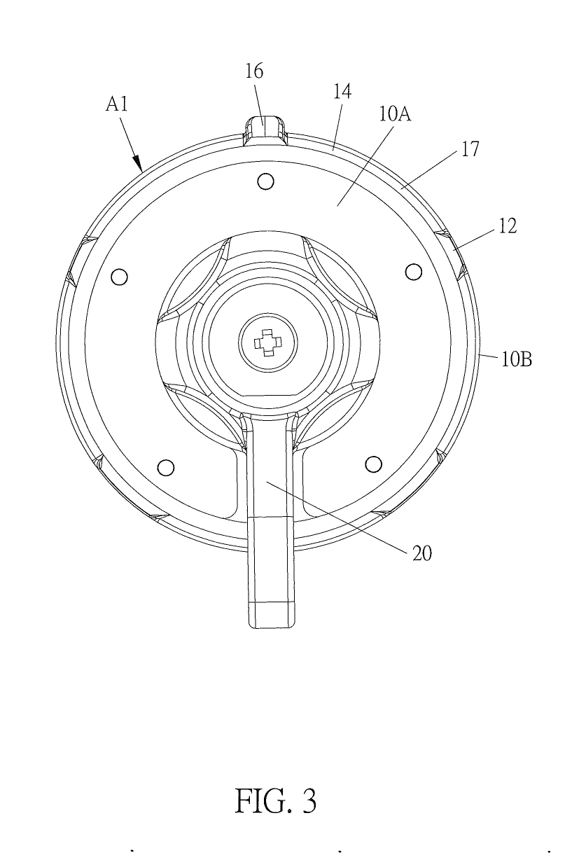

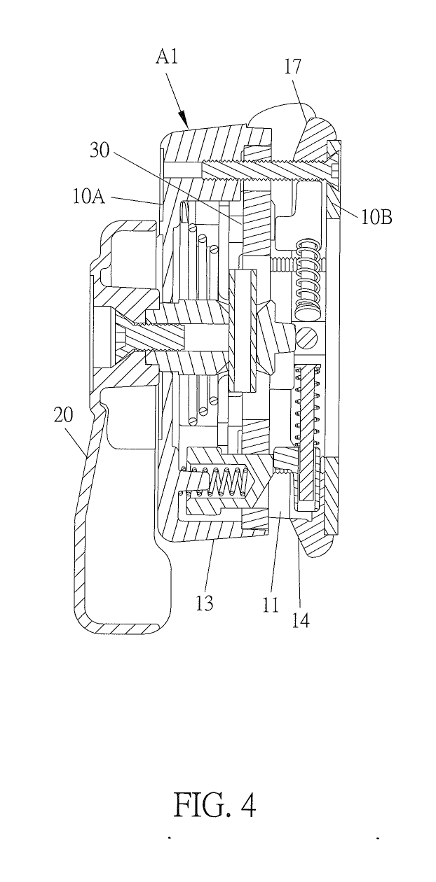

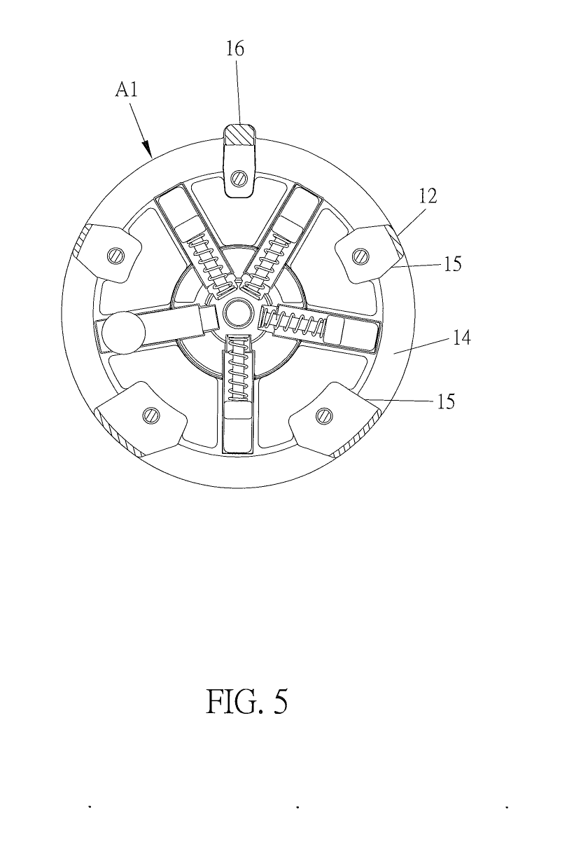

With reference to FIGS. 1 to 5, a buckle structure for a seat belt of a race car according to a preferred embodiment of the present invention comprises: a buckle A1 and a plurality of fastening pieces A2, wherein the buckle A1 includes an upper cover 10A, a lower cover 10B, an unfastening member 20, and a locking device 30. The upper cover 10A and the lower cover 10B are formed in a disc shape and are connected together by using at least one screw, the upper cover 10A has plural holes 11 defined around a peripheral side thereof relative to the lower cover 10B, and each hole 11 has two long fringes corresponding to the upper cover 10A and the lower cover 10B and has two short fringes defined between the two long fringes and between the upper cover 10A and the lower cover 10B. Between any two of the plural holes 11 is defined a partition 12 to separate any two of the plural holes 11, one of the two long fringes of each hole 11 adjacent to the upper cover 10A has a tilted guiding face 13, a depth of which increases toward each hole 11, and the other of the two long fringes of each hole 11 proximate to the lower cover 10B has a guide rim 14, a depth of which increases toward each hole 11. Each short fringe of each hole 11 has a guiding periphery 15 decreasing inwardly and slanting toward each hole 11, and the tilted guiding face 13 has two slopes in each hole 11, wherein one of the two slopes of the tilted guiding face 13 adjacent to each hole 11 is greater than the other of the two slopes away from each hole 11. In addition, the buckle A1 includes a marking block 16 mounted on an outer peripheral side thereof and keeping away from the plural holes 11. In this embodiment, the marking block 16 is a rib mounted on the lower cover 10B of the buckle A1, and the lower cover 10B also has a shoulder 17 arranged around outer peripheral sides of the plural holes 11, the tilted guiding face 13 is located between each hole 11 and the shoulder 17. The unfastening member 20 is rotatably fixed on the upper cover 10A, the locking device 30 is mounted between the upper cover 10A and the lower cover 10B and is driven by the unfastening member 20. Each fastening piece A2 has a first end connecting with a seat belt 40 and a second end having a connector 50 on which a lock aperture 51 is formed.

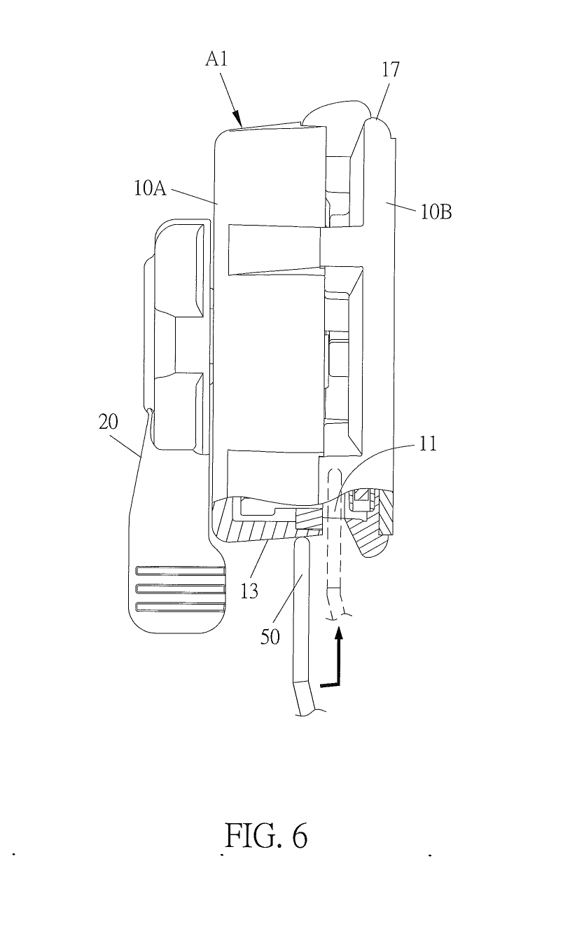

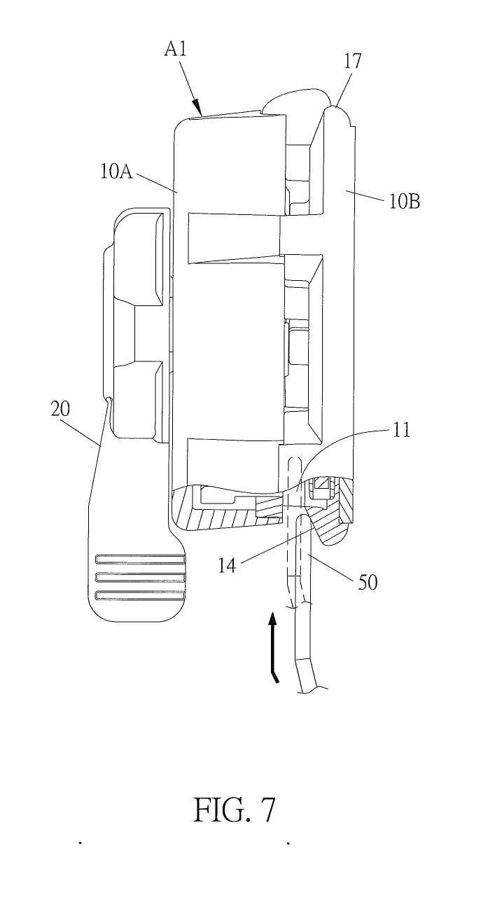

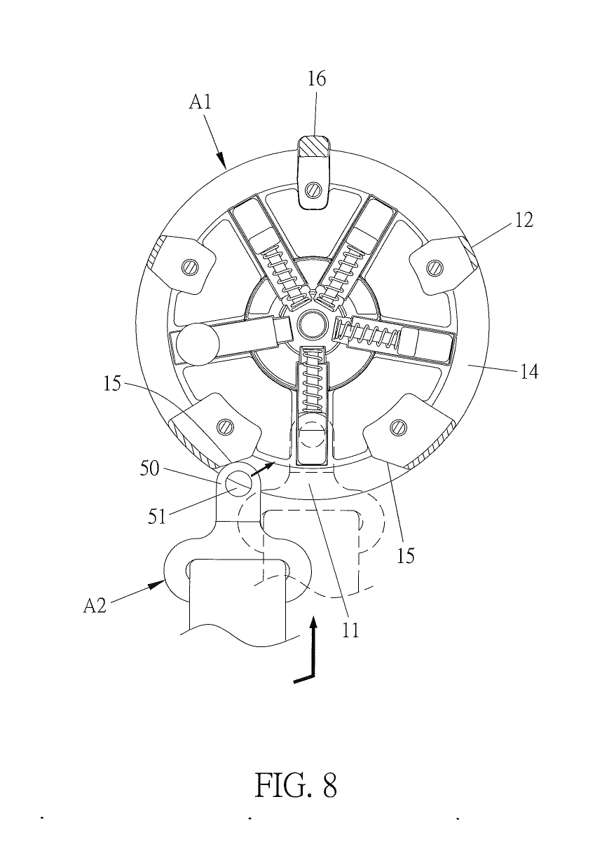

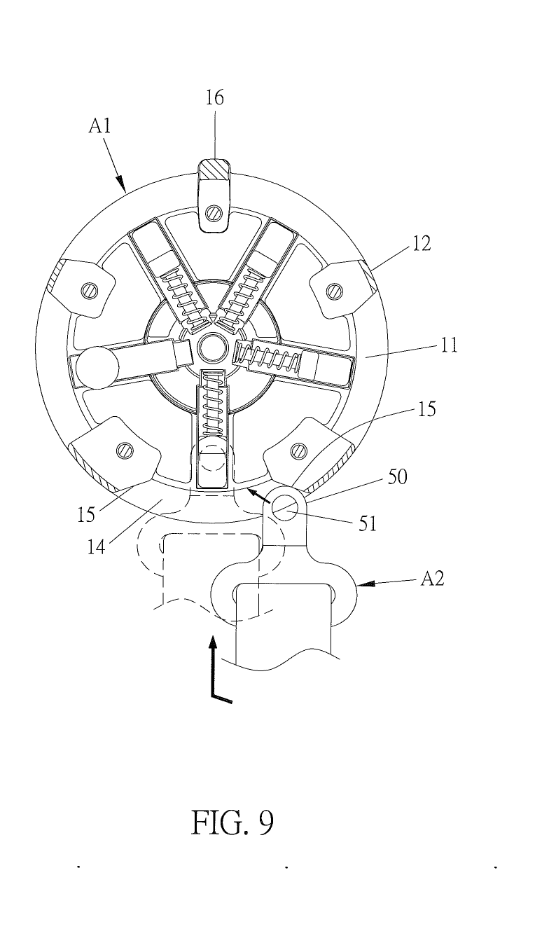

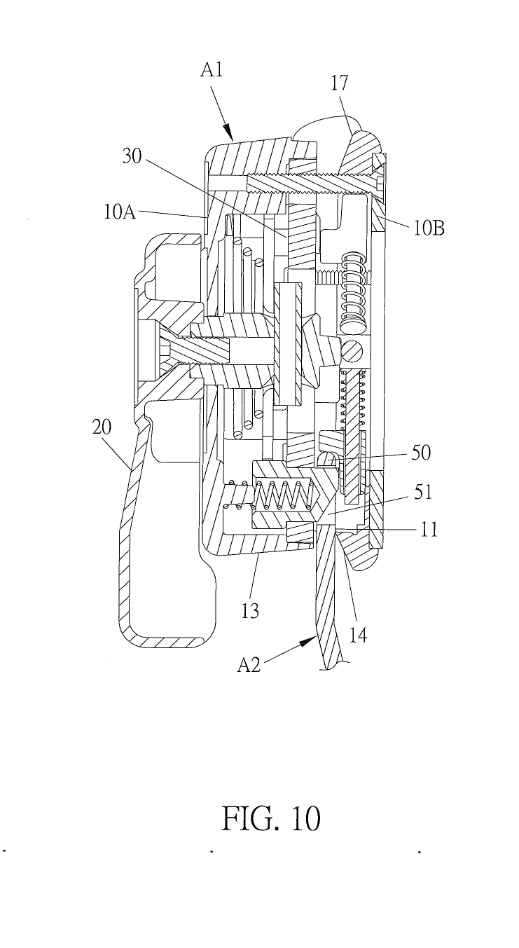

With reference to FIGS. 6 to 10, in operation, the connector 50 of each fastening piece A2 is inserted into one of the plural holes 11 of the buckle A1, and the lock aperture 51 of the connector 50 is engaged with the locking device 30, wherein when the connector 50 of each fastening piece A2 is inserted into the one of the plural holes 11, it is guided to slide into the one of the plural holes 11 by ways the two slopes of the tilted guiding face 13 or a slope of the guide rim 14 or the guiding periphery 15, such that the connector 50 slides into the one of the plural holes 11. Preferably, when the connector 50 does not slide into the one of the plural holes 11 exactly. and then slips off the one of the plural holes 11, the shoulder 17 of the lower cover 10B stops the connector 15 slipping off the one of the plural holes 11, and the guide rim 14 guides the connector 15 to slide into and engage with the one of the plural holes 11.

When the unfastening member 20 is rotated to drive the locking device 30, the locking device 30 disengages from the lock aperture 51 of the connector 50 of each fastening piece A2, such that the connector 50 of each fastening piece A2 removes from the one of the plural holes 11 of the buckle A1.

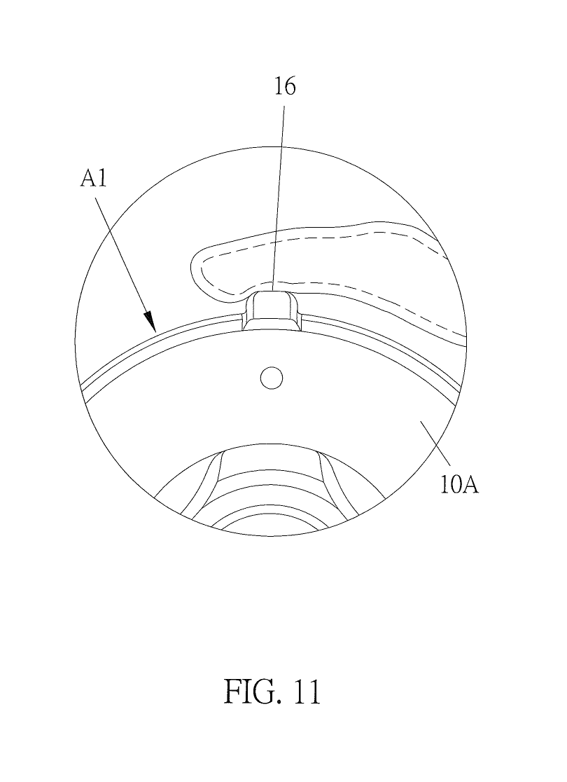

To increase safety of a racing driver, as shown in FIG. 11, he/she wears a neck guard and buckles the seat belt but cannot bow his/her head to see whether the seat belt is buckled. In the meantime, the marking block 16 helps the racing driver touches the one of the plural hole 11 of the buckle A1 accurately, after he/she wears gloves and inserts the connector 50 of each fastening piece A2 into the one of the plural holes 11, thus engaging the connecter 50 with the one of the plural holes 11 of the buckle A1 quickly and exactly.

Thereby, the buckle structure for the seat belt of the race car comprises: the tilted guiding face 13 on the one of the two long fringes of each hole 11, the guide rim 14 on the other of the two long fringes of each hole 11, and the guiding periphery 15 on each short fringe of each hole 11, such that after the racing driver buckles the seat belt and cannot see whether the seat belt is buckled, because he/she is limited by the neck guard and the seat belt, the tilted guiding face 13, the guide rim 14, and the guiding periphery 15 guide the connector 50 to insert into and engage with the buckle A1 quickly and exactly, thus enhancing using convenience.

Preferably, the marking block 16 helps the racing driver touches the one of the plural hole 11 of the buckle A1 accurately, after wearing the gloves and inserting the connector 50 of each fastening piece A2 into the one of the plural holes 11, thus engaging the connecter 50 of each fastening piece A2 with the one of the plural holes 11 of the buckle A1 quickly and exactly.

While various embodiments in accordance with the present invention have been shown and described, it is clear to those skilled in the art that further embodiments may be made without departing from the scope of the present invention.

What is claimed is:

1. A buckle structure for a seat belt of a race car comprising:
a buckle including an upper cover, a lower cover, an unfastening member, and a locking device;
the upper cover and the lower cover being formed in a disc shape and being connected together, the upper cover having plural holes defined around a peripheral side thereof relative to the lower cover, and each hole having two long fringes corresponding to the upper cover and the lower cover, each hole also having two short fringes defined between the two long fringes and between the upper cover and the lower cover, between any two of the plural holes beings defined a partition, and one of the two long fringes of each hole adjacent to the upper cover having a tilted guiding face, a depth of which increases toward each hole, and the other of the two long fringes of each hole proximate to the lower cover having a guide rim, a depth of which increases toward each hole, each short fringe of each hole having a guiding periphery decreasing inwardly and slanting toward each hole;
the unfastening member being rotatably fixed on the upper cover;
the locking device being mounted between the upper cover and the lower cover and being driven -by the unfastening member; and
a plurality of fastening pieces, wherein each fastening piece has a first end connecting with a seat belt and a second end having a connector on which a lock aperture is formed;
wherein the connector of each fastening piece is inserted into one of the plural holes of the buckle, and the lock aperture of the connector is engaged with the locking device, and wherein when rotating the unfastening member, the locking device is driven to disengage from the one of the plural holes; when the connector is inserted into the one of the plural holes, it is guided to slide into the one of the plural holes by ways any one of the tilted guiding face, the guide rim, and the guiding periphery.

2. The buckle structure for the seat belt of the race car as claimed in claim 1, wherein the tilted guiding face has two slopes in each hole, wherein one of the two slopes of the tilted guiding face adjacent to each hole is greater than the other of the two slopes away from each hole.

3. The buckle structure for the seat belt of the race car as claimed in claim 1, wherein the lower cover also has a shoulder arranged around outer peripheral sides of the plural holes, the tilted guiding face is located between each hole and the shoulder, when the connector does not slide into the one of the plural holes and then slips off the one of the plural holes, the shoulder stops the connector slipping off the one of the plural holes, and the guide rim guides the connector to slide into and engage with the one of the plural holes.

4. A buckle structure for the seat belt of the race car comprising:
a buckle including an upper cover, a lower cover, an unfastening member, and a locking device;
the upper cover and the lower cover being formed in a disc shape and being connected together, the upper cover having plural holes defined around a peripheral side thereof relative to the lower cover, and each hole having two long fringes corresponding to the upper cover and the lower cover, each hole also having two short fringes defined between the two long fringes and between the upper cover and the lower cover, between any two of the plural holes beings defined a partition, and one of the two long fringes of each hole adjacent to the upper cover having a tilted guiding face, a depth of which increases toward each hole, and the other of the two long fringes of each hole proximate to the lower cover having a guide rim, a depth of which increases toward each hole, each short fringe of each hole having a guiding periphery decreasing inwardly and slanting toward each hole, the buckle including a marking block mounted on an outer peripheral side thereof and keeping away from the plural holes;
the unfastening member being rotatably fixed on the upper cover;
the locking device being mounted between the upper cover and the lower cover and being driven by the unfastening member; and
a plurality of fastening pieces, wherein each fastening piece has a first end connecting with a seat belt and a second end having a connector on which a lock aperture is formed;
wherein the connector of each fastening piece is inserted into one of the plural holes of the buckle, and the lock aperture of the connector is engaged with the locking device, and wherein when rotating the unfastening member, the locking device is driven to disengage from the one of the plural holes; when the connector is inserted into the one of the plural holes, it is guided to slide into the one of the plural holes by ways any one of the tilted guiding face, the guide rim, and the guiding periphery.

5. The buckle structure for the seat belt of the race car as claimed in claim 4, wherein the tilted guiding face has two slopes in each hole, wherein one of the two slopes of the tilted guiding face adjacent to each hole is greater than the other of the two slopes away from each hole.

6. The buckle structure for the seat belt of the race car as claimed in claim 4, wherein the lower cover also has a shoulder arranged around outer peripheral sides of the plural holes, the tilted guiding face is located between each hole and the shoulder, when the connector does not slide into the one of the plural holes and then slips off the one of the plural holes, the shoulder stops the connector slipping off the one of the plural holes, and the guide rim guides the connector to slide into and engage with the one of the plural holes.
